(19) United States
(12) Patent Application Publication
(10) Pub. No.: US 2004/0108815 A1
(43) Pub. Date: Jun. 10, 2004

(54) Microwave-excited elecrodeles discharge bulb and microwave-excited discharge lamp system

(76) Inventors: Shin Ukegawa, Kyoutanabe-shi (JP); Tsutomu Kobayashi, Yawata-shi (JP); Motohiro Sami, Hirakata-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/474,178

(22) PCT Filed: Feb. 21, 2003
(86) PCT No.: PCT/JP03/01956

(30) Foreign Application Priority Data
Feb. 25, 2002 (JP) 2002-048795

(51) Int. Cl. H01J 17/20

(52) U.S. Cl. 313/637

(57) ABSTRACT

An improved microwave-excited electrodeless discharge bulb and a lamp system using the bulb are designed to produce a nearly white light at an increased luminous efficacy. The bulb encloses a filling containing a mixture of a rare earth halide, a sodium halide, mercury, and a rare gas. The rare earth halide is at least one selected from a group consisting of a cerium halide and praseodymium halide. With the inclusion of cerium halide and/or praseodymium halide in combination with the mercury, the bulb can produce nearly white light at superior luminous efficacy, when energized by the microwave.

### TECHNICAL FIELD

The present invention is directed to a microwave-excited electrodeless discharge bulb and a microwave-excited discharge lamp system using the bulb.

### BACKGROUND ART

Japanese Patent Early Publication No. 10-69890 discloses a microwave-excited electrodeless discharge bulb which is energized by a microwave to produce light. The bulb contains a filling of indium bromide and argon. However, the bulb is not satisfactory as it gives only low luminous efficacy.

WO 92/08240 discloses a like microwave-excited electrodeless discharge bulb. The bulb contains a filling of either selenium or sulfur and a small amount of rare gas without the inclusion of mercury. The bulb shows an emission spectrum characterized to give a relatively strong green color at 550 nm to result in a greenish white that are strange to human eyes. A color compensating filter may be applied but reduces luminous efficacy. Therefore, it is desired to provide nearly white light at high luminous efficacy.

In this regards, it is found that the inclusion of mercury together with a combination of particular rare earth halide and sodium halide can provide nearly white light as well as improve luminous efficacy. In fact, the inclusion of mercury for the microwave excitation bulb can elongate a penetration depth that the microwave energy advances from the surface of the bulb to the inside of the bulb, thereby increasing an effective luminescent zone within the bulb responsible for giving the light output.

U.S. Pat. No. 5,363,015 discloses an electrodeless discharge bulb or lamp which is energized by a radio frequency electromagnetic field of 13.56 MHz. The bulb contains a filling of praseodymium halide, rare earth halide, sodium halide, and cesium halide. The bulb is made mercury free and is designed to be energized by the RF of 13.56 MHz quite far from the microwave. Therefore, if the mercury should be added to a considerable amount, the bulb would suffer from a considerable mismatch in lamp impedance between at the time of starting the lamp and the time of keeping the bulb operated due to a high vapor pressure inherent to the mercury. With this result, when a source of generating RF is matched to the impedance of the bulb given while being kept operated, the lamp starting is made rather difficult. On the other hand, when the RF source is matched to the impedance given at the time of starting the lamp, the bulb possibly suffers from extinction prior to advancing to stable operating condition or suffers from lowering of the luminous efficacy during the stable lighting operation due to the resulting power reflection.

### DISCLOSURE OF THE INVENTION

The present invention has been achieved in view of the above to provide an improved microwave-excited electrodeless discharge bulb and a microwave-excited discharge lamp system using the bulb. The bulb in accordance with the present invention encloses a filling containing a mixture of a rare earth halide, a sodium halide, mercury, and a rare gas. The rare earth halide is at least one selected from a group consisting of a cerium halide and praseodymium halide. With the inclusion of cerium halide and/or praseodymium halide in combination with the mercury, the bulb can produce nearly white light at superior luminous efficacy, when energized by the microwave.

The cerium halide may be at least one selected from a group consisting of cerium iodide, cerium bromide, and cerium chloride. Likewise, the praseodymium halide is at least one selected from a group consisting of praseodymium iodide, praseodymium bromide, and praseodymium chloride.

Preferably, the mercury is contained in an amount of at least 2 mg/cm³ in a volume of the bulb in order to increase the effective luminescent zone for producing the light within the volume of the bulb, thereby improving improve the luminous efficacy.

The rare earth halide and sodium halide are contained in a molar ratio of a corresponding rare earth element to sodium 1:1 to 1:10, most preferably 1:3.5 to 1:5.5. Within this range of the molar ratio, it is quite easy to dim the light without being accompanied with a large variation in the correlated color temperature of the light.

The present invention also provides a microwave-excited discharge lamp system comprising a microwave generator, a microwave cavity placing therein the electrodeless discharge bulb enclosing the above-mentioned filling, and a waveguide directing the microwave to the microwave cavity such that the microwave cavity gives an electromagnetic field that excites the filling for emitting a luminous radiation out the microwave cavity. Thus, the system enables the bulb to produce the nearly white light at an increase luminous efficacy.

These and still other objects and advantageous features of the present invention will become more apparent from the following description of the embodiments when taken in conjunction with the attached drawings.

### BRIEF DESCRIPTION OF THE DRAWINGS

FIG. 1 is a perspective view of a microwave-excited discharge lamp system in accordance with a preferred embodiment of the present invention;

FIG. 2 is a sectional view of the above lamp system;

FIG. 3 shows a field intensity generated across a discharge tube of the system prior to being discharged;

FIG. 4 shows a field intensity generated across a discharge tube of the system after being discharged;

FIG. 5 is a graph showing spectral distribution of the light from the bulb;

FIG. 6 is a graph showing spectral distribution of a light emitted from a bulb of the same filling but provided with electrodes;

FIG. 7 is a graph showing a relation between an input wattage and luminous efficacy of the above bulb;

FIG. 8 is a graph showing a relation between a mercury density and relative efficacy of the above bulb;

FIG. 9 shows a luminescence intensity of the bulb containing small mercury amount;

FIG. 10 shows a luminescence intensity of the bulb containing large mercury amount;

FIG. 11 a graph showing a relation between an input wattage and luminous efficacy of a discharge bulb in accordance with a second embodiment of the present invention;

FIG. 12 is a graph showing a relation between the input wattage and correlated color temperature of the above bulb;

FIG. 13 is a graph showing a relation between the input wattage and a chromaticity deviation [Duv] from a blackbody locus in the u-v chromaticity coordinate for the light emitted from the bulb;

FIG. 14 shows the correlated color temperature (CCT) with varying input wattages and also with varying molar ratio of Na to Pr for the above bulb; and

FIG. 15 is a graph showing spectral distribution of the light from the above bulb.

### DETAILED DESCRIPTION OF THE PREFERRED EMBODIMENTS

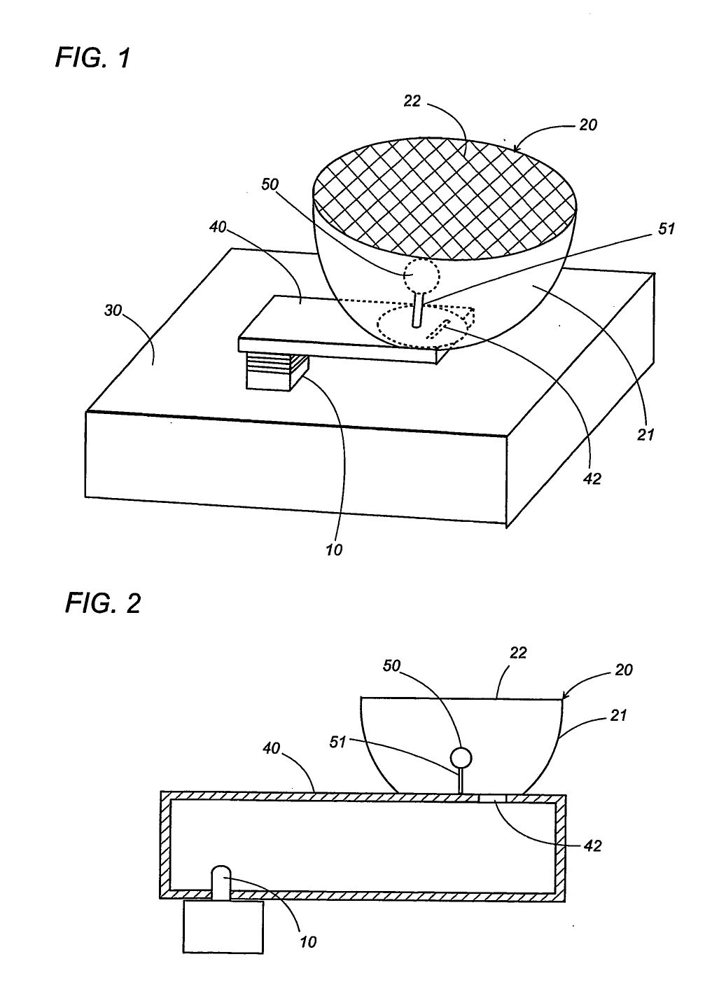

Referring now to FIGS. 1 and 2, there is shown a microwave-excited electrodeless discharge lamp system in accordance with a preferred embodiment of the present invention. The system includes a microwave generator 10 or magnetron generating a microwave energy having a frequency of 2.45 GHz, for example, and microwave cavity 20 in the form of a cavity resonator placing therein a discharge bulb 50. The generator 10 is mounted on a base 30 and is coupled to the microwave cavity 20 through an elongated waveguide 40 having a rectangular cross section of 109 mm×54.5 mm and having a coupling slot 42 for transmitting the microwave energy into the microwave cavity 20.

The microwave cavity 20 is shaped into a semi-spherical configuration having a paraboloidal bowl 21 of 75 mm height and a circular top plate 22 of 190 mm diameter closing the top of the cavity. The paraboloidal bowl 21 is made of an aluminum plate, for example, to give high reflectivity to a visible light, while the top plate 22 is made of a metal net, for example, which is permeable to the visible light and impermeable to the microwave power. The paraboloidal bowl 21 and the top plate 22 are electrically interconnected to constitute an electromagnetic shield.

The bulb 50 is made of fused quartz into a hermetically sealed structure and is disposed in the center of the cavity 20 as being supported to the bottom of the paraboloidal bowl 21 by means of a quartz-made stud 51. The bulb 50 is generally spherical and has an outside diameter of 27 mm and an inside diameter of 25 mm. Enclosed within the bulb is a filling which contains a mixture of 30 Torr of argon, 40 mg of mercury, 5 mg of cerium iodide, and 10 mg of sodium iodide with a resulting molar ratio of cerium to sodium (Ce:Na) being about 1:7. The bulb including the above composition is herein after referred to as Example 1.

The microwave cavity 20 is designed to resonate the microwave energy reaching the coupling slot 42 at the frequency of 2.45 GHz in order to ionize and excite the gas within the bulb 50 for producing the light. At an initial stage of the gas discharging, the mercury is chiefly responsible for the gas discharging. As the bulb wall temperature rises by an effect of heat generated by the gas discharging, the metal halides, i.e., cerium iodide and sodium iodide that are solid in a room temperature are evaporated to be dissociated into corresponding metal atoms and the halogen atoms. Whereby, the metal atoms (cerium and sodium) are excited to produce the visible light which passes through the top plate 22 directly or after being reflected on the inner surface of the paraboloidal bowl 21.

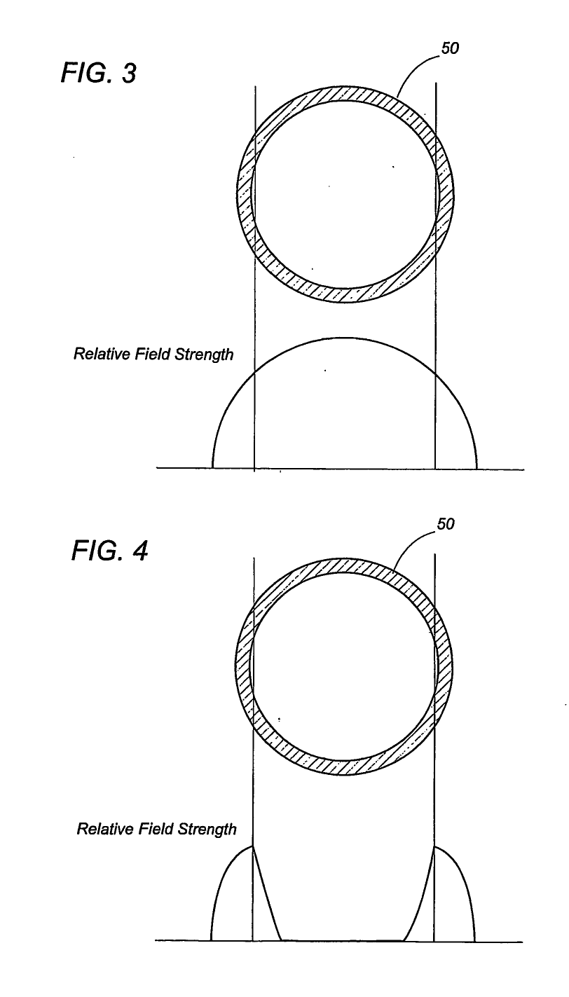

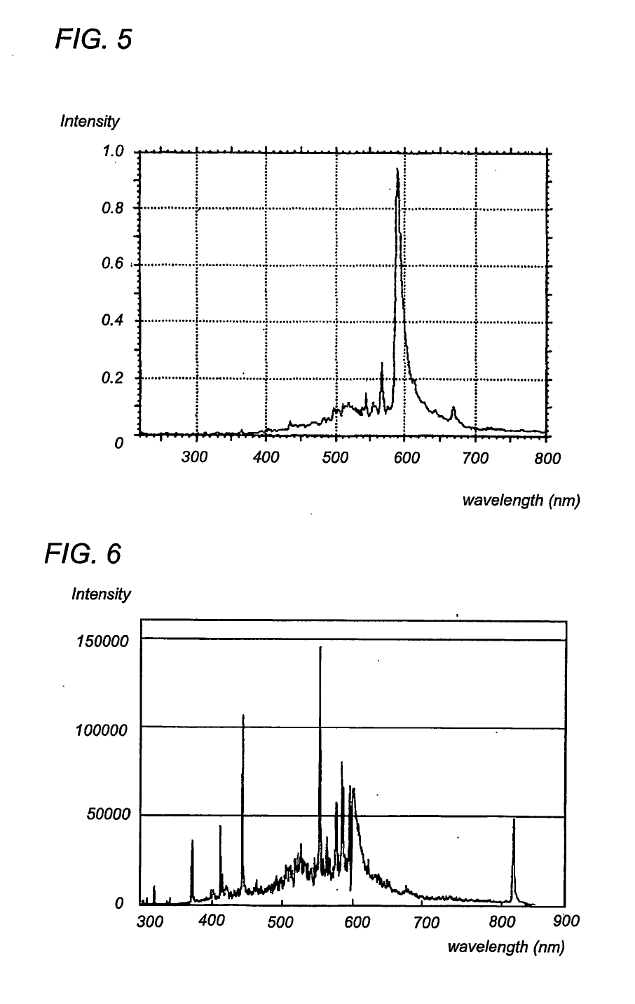

The bulb 50 is positioned within the cavity 20 to receive a field intensity developed across the bulb 50 before starting of the discharge, as shown in FIG. 3. After the discharging starts, a conductive plasma is generated within the bulb to cancel the field and leave the intense field only in the vicinity of the bulb wall, as shown in FIG. 4. Thus, the intense visible light is produced only from the vicinity of the bulb wall. The resulting light shows a spectral distribution, as shown in FIG. 5, which demonstrates that “Ce” produces the light of wavelengths covering the broad visible range, while “Na” produces prominently the light of around 590 nm wavelength. The spectral distribution obtained with the electrodeless bulb is quite different from that obtained with an electroded bulb which encloses the same filling but has electrodes and energized by a ballast applying an AC voltage across the electrodes. FIG. 6 shows the spectral distribution for the electroded bulb and demonstrates a considerable difference from that of FIG. 5 in a manner that “Na” acts to give off the light, i.e., an intensity drop of the intensity of the light around 590 nm wavelength. That is, because of that the electroded bulb generates the discharging in the center of the bulb, the light caused by “Na” in the center of the bulb will suffer from a self-absorption, i.e., reabsorption in sodium atoms before reaching the bulb wall, and therefore cannot wholly propagate out through the bulb wall, which results in lowering of the luminous efficacy of the light caused by “Na”. In contrast, the electrodeless bulb of the present embodiment is substantially free from the reabsorption of the light caused by “Na” to assure an improved luminous efficacy.

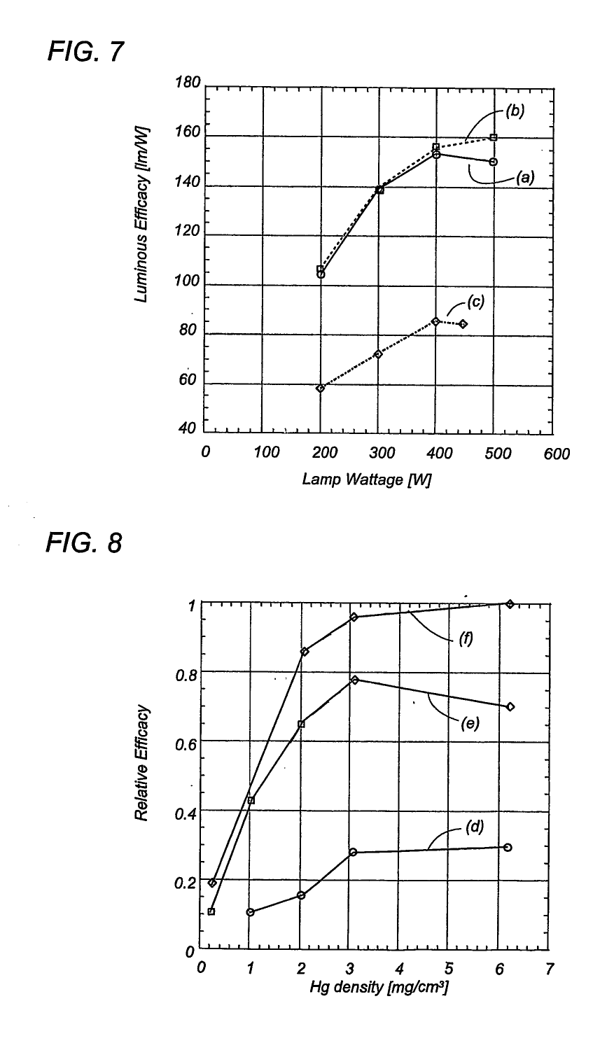

FIG. 7 is a graph showing a relation between an input wattage and luminous efficacy for the bulb of Example 1 and the bulb corresponding to Japanese Patent Early Publication No. 10-69890 filled with indium bromide InBr. The bulbs were tested in the same environment using the same microwave generating system. In the graph, a curve (a) denotes the luminous efficacy of the bulb of Example 1 filled with cerium iodide and sodium iodide, while a curve (c) denotes that of the bulb filled with InBr. As is clear from the graph, the bulb of Example 1 demonstrates the luminous efficacy superior to the conventional bulb, while producing the near white light. This is because of a combination effect of that cerium gives off the light effectively and that sodium is free from the self-absorption due to the microwave excitation. The light produced by the bulb of Example 1 is measured to have a correlated color temperature (CCT) of 3028 K, an average color rendering index of 65, and a chromaticity deviation [Duv] of 0.006 from a blackbody locus in the u-v chromaticity coordinate.

Also in the graph, curve (b) is plotted to denote the luminous efficacy for a bulb filled with sodium iodide and praseodymium iodide PrI₃ instead of the cerium iodide as will be disclosed later as Example 2. It is confirmed that the bulb of Example 2 also demonstrates superior luminous efficacy compared to the curve (c) for the conventional bulb. It is noted in this connection that the bulb of the present invention exhibits the efficacy of about 150 lm/W at the input wattage of 400 W, which is about 1.9 times greater than the conventional microwave-excited bulb including indium bromide and also 1.5 times greater than the above-mentioned electroded bulb.

Further, it is made to examine the amount of mercury added to the filling for improving the luminous efficacy. The results are shown in FIG. 8 in which curves (d), (e), and (f) denote the relative efficacy with varying amount of the mercury, respectively for different bulb wall loadings of 15 W/cm², 20 W/cm², and 25 W/cm². The bulb wall loading corresponds to the input wattage and therefore relates directly to the bulb temperature and the efficacy. As is clear from the figure, the mercury added in an amount of 2 mg/cm³ or more will greatly increase the efficacy, which is believed to be achieved particularly for the microwave-excited bulb. If the mercury should be added in an increased amount in the electroded bulb, the bulb suffers from increased elastic collision as well as convection losses of the gas, and therefore the lowered efficacy. Further, the electroded bulb may cause unduly high lamp voltage or unstable discharging due to the convection of the gas. In the microwave-excited electrodeless bulb, however, the increasing amount of the mercury brings about an increased internal resistance within the bulb as a result of that the evaporated mercury acts mainly as a buffer gas. That is, the mercury has an ionization voltage higher than the halides and is not ionized prior to the halides.

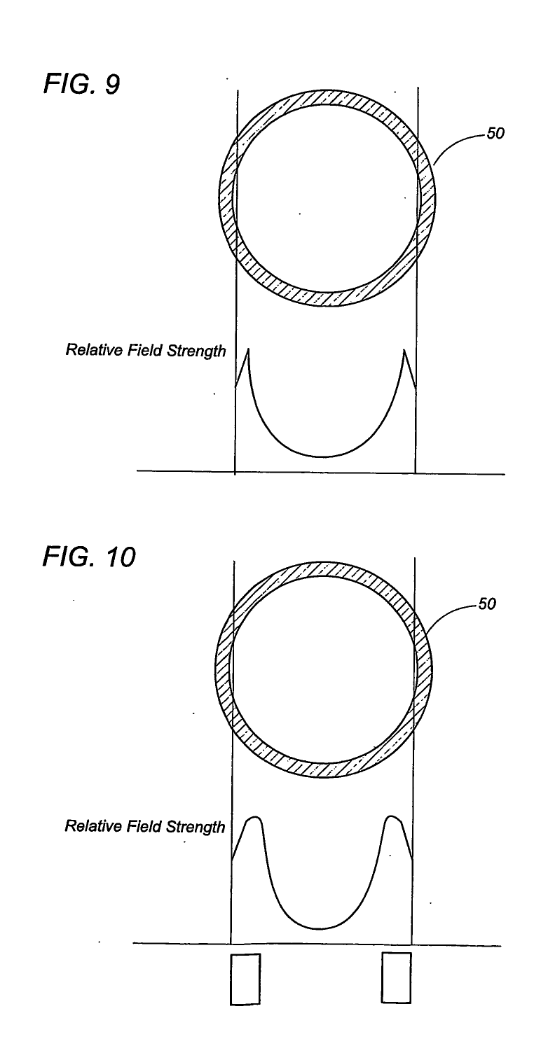

FIGS. 9 and 10 are presented for easy confirmation of the above effect of the mercury. As explained hereinbefore, the microwave-excited electrodeless bulb will give off the light only from the vicinity of the bulb wall. When the mercury is added in an amount of less than 2 mg/cm³, the relative luminescence intensity exhibits the curve as shown in FIG. 9. While, on the other hand, when the mercury is added in an amount of 2 mg/cm³ or more, the relative luminescence intensity exhibits the curve of FIG. 10 with attendance increase in a light emitting zone of producing the intense light along the diameter of the bulb. Thus, the addition of the mercury in an amount of 2 mg/cm³ or more is particularly advantageous for improving the luminous efficacy. Also, with this effect, the plasma moves inward to some extent away from the bulb wall, thereby restraining undesired chemical reaction of the filling with the quartz forming the bulb and therefore avoiding the deterioration of the bulb to assure a prolonged bulb life. However, the added amount of the mercury is preferred not to exceed 50 mg/cm³ as it might increase the elastic collision loss or cause the reabsorption loss because of the undue increase of the light emitting zone.

The bulb diameter may be designed to have a reduced outside diameter of 23 mm. The characteristics of the bulb are also measured to show the luminous efficacy of 150 lm/W at 350 W input wattage, a correlated color temperature of 3028 K, an average color rendering index of 65, and a chromaticity deviation [Duv] of 0.006 from a blackbody locus in the u-v chromaticity coordinate.

Quartz-made spherical bulbs of Examples 2 to 4 are prepared to have an outside diameter of 23 mm (inside diameter of 21 mm) and enclose a filling containing a mixture of 30 Torr of argon, 30 mg of mercury, and 8 mg of praseodymium iodide and sodium iodide with a varying molar ratio of praseodymium to sodium, as listed in table below.

| | Example 2 | | Example 3 | | Example 4 | |
|---|---|---|---|---|---|---|
| Argon | 30 | Torr | 30 | Torr | 30 | Torr |
| Mercury | 30 | mg | 30 | mg | 30 | mg |
| Praseodymium | 6.2 | mg | 4 | mg | 3.1 | mg |
| iodide | | | | | | |
| Sodium iodide | 1.8 | mg | 4 | mg | 4.9 | mg |

| | | | |
|---|---|---|---|
| Molar ratio of Pr:Na | 1:1 | 1:3.5 | 1:5.5 |

Examples 2 to 4 are prepared for evaluating an optimum molar ratio of Pr to Na in view of the characteristics including the correlated color temperature, luminous efficacy, dimming performance, and lamp life.

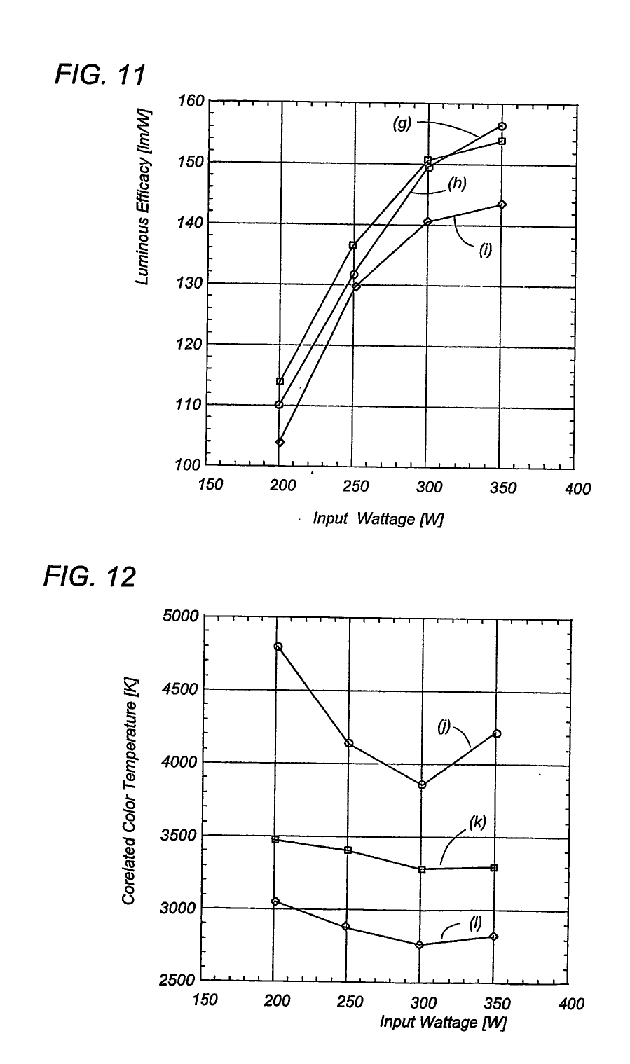

FIG. 11, which is analogous to FIG. 7 for Example 1, shows the luminous efficacy (lm/W) measured for Example 2 to 4 with varying input wattage, in which curves (g), (h), and (i) denote respectively Examples 2, 3, and 4. From this figure, it is known that the bulbs of Examples 2 to 4 provide an improved efficacy 1.5 times greater the electroded bulb as mentioned with reference to Example 1, over the input wattage range of 300 W to 350 W.

FIG. 12 shows the correlated color temperature (K) measured for Example 2 to 4 with varying input wattage, in which curves (j), (k), and (l) denote respectively Examples 2, 3, and 4. From this result, it is known that the color temperature of the bulb can be easily adjusted by varying the molar ratio of Pr to Na, while the bulb of Example 3 and 4 can keep the color temperature relatively constant with varying input wattage, which is particularly advantageous for dimming the bulb without accompanying a discernible change in color. It is noted here that the bulbs of Examples 1 and 2 also give less color temperature variation with the varying input voltage as compared to the electroded bulb. Also, commercially available conventional metal halide bulbs are known to suffer from a considerable color temperature change while being dimmed. In this respect, the bulb of the present invention is advantageous in its constant color dimming performance over the conventional bulbs.

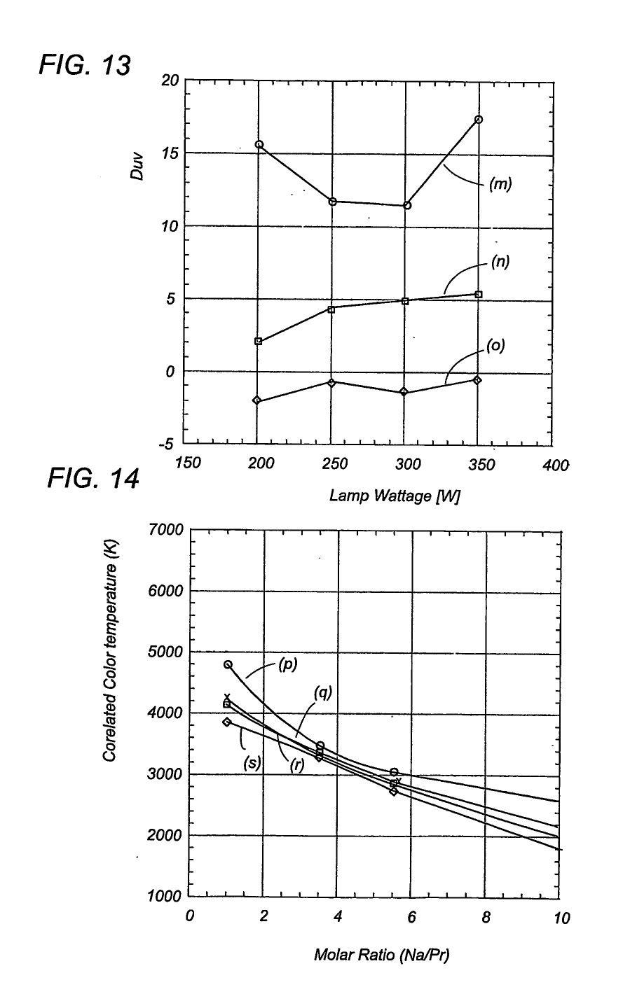

FIG. 13 shows a chromaticity deviation [Duv] from a blackbody locus in the u-v chromaticity coordinate measured for Examples 2 to 4, with Duv being multiplied by 1000 for giving an easy calibration standard in which Duv of −12 to +12 manifests a natural white light. Curves (m), (n), and (o) denote respectively Examples 2, 3, and 4. From this result, it is found that as the molar ratio of Pr to Na becomes greater, the resulting light becomes towards true white. Thus, Examples 3 and 4 having the molar ratio of 1:3.5 to 1:5.5 are most preferable for providing the light as close to white as possible.

FIG. 14 shows the correlated color temperature (CCT) with varying input wattages and also with varying molar ratio of Pr to Na by extrapolation on the basis of the results of Examples 2 to 4, in which curves (p), (q), (r), and (s) denote the CCT for the bulb operated at the input wattages of 200 W, 250 W, 300 W, and 350 W, respectively. Evaluation of the results makes it clear that Pr:Na molar ratio of 1:1 to 1:10 can give CCT of 5000 K to 2000 K to the bulb for use in various lighting environments where rather white color is sufficient, that Pr:Na molar ratio of 1:1 to 1:7 can give CCT of 5000 K to 3000 K to the bulb required to produce the nearly white light, and that Pr:Na molar ratio of 1:1 to 1:4 can give CCT of 4200 K to 3200 K to the bulb for use as a high bay mounted lamp or street lamp requiring a long lamp life in addition to the nearly white light.

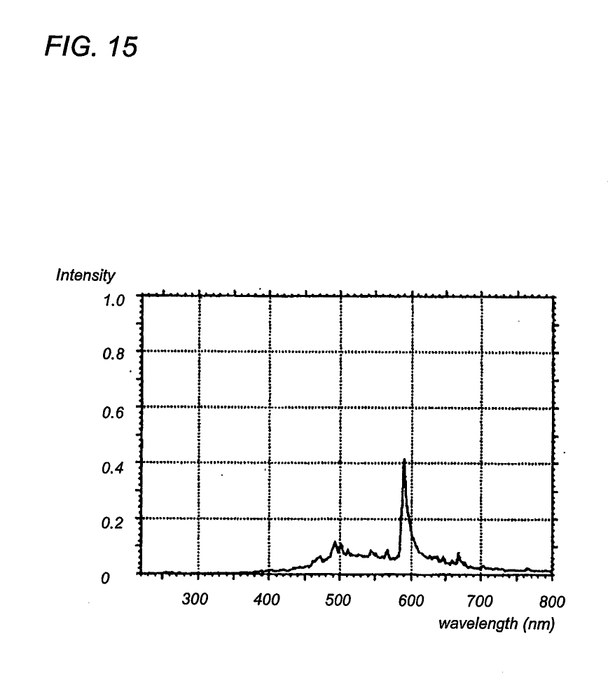

As is confirmed in FIG. 15 which exemplarily illustrates the spectral distribution of Example 3, the bulb is given improved luminous efficacy as a combination result of the non-reabsorption of Na around the wavelength of 590 nm due to the microwave-excitation, and a broad distribution of the wavelengths due to the inclusion of praseodymium.

In the above Examples, only cerium iodide and praseodymium iodide are shown respectively as the cerium halide and praseodymium halide, it should be noted that cerium bromide, cerium chloride can be equally utilized as the cerium halide, and that praseodymium bromide and praseodymium chloride can be also equally utilized as the praseodymium halide, since the ionized cerium and praseodymium are responsible for producing the light. Further, although not specifically included in the description, it is also possible to combine any one of the cerium halides with any one of the praseodymium halides since both of the ionized cerium and praseodymium are responsible for producing the near white light effectively in combination with the ionized sodium.

Although the above embodiments illustrate the microwave cavity in the semi-spherical shape, the cavity may take any suitable shape such as polyhedron, a part of ellipsoid of revolution, or cylinder. Also, the bulb may be shaped into any suitable configuration. Further, the microwave may alternatively transmitted by use of a coaxial cable rather than the illustrated waveguide. In this regard, the waveguide may be coupled to the microwave cavity by means of an antenna rather than the illustrated coupling slot.

1. A microwave-excited electrode-less discharge bulb, said discharge bulb enclosing a filling which contains a mixture of
a rare earth halide,
a sodium halide,
mercury, and
a rare gas,
wherein said rare earth halide is at least one selected from a group consisting of a cerium halide and praseodymium halide.

2. The discharge bulb as set forth in claim 1, wherein
said cerium halide is at least one selected from a group consisting of cerium iodide, cerium bromide, and cerium chloride, and
said praseodymium halide is at least one selected from a group consisting of praseodymium iodide, praseodymium bromide, and praseodymium chloride.

3. The discharge bulb as set forth in claim 1, wherein
said mercury is contained in an amount of 2 mg/cm³ or more in a volume of said bulb.

4. The discharge bulb as set forth in claim 1, wherein
said rare earth halide and said sodium halide are contained in a molar ratio of a corresponding rare earth element to sodium 1:1 to 1:10.

5 The discharge bulb as set forth in claim 1, wherein
said rare earth halide and said sodium halide are contained in a molar ratio of a corresponding rare earth element to sodium 1:3.5 to 1:5.5.

6. A microwave excited discharge lamp system comprising:
a microwave generator generating a microwave;
a microwave cavity placing therein an electrode-less discharge bulb enclosing a filling;
a waveguide directing said microwave to said microwave cavity such that said microwave cavity gives an electromagnetic field that excites said filling for emitting a luminous radiation out of said microwave cavity;
said filling containing a mixture of
a rare earth halide,
a sodium halide,
mercury, and
a rare gas,
wherein said rare earth halide is at least one selected from a group consisting of a cerium halide and praseodymium halide.

7. The lamp system as set forth in claim 6, wherein
said cerium halide is at least one selected from a group consisting of cerium iodide, cerium bromide, and cerium chloride, and
said praseodymium halide is at least one selected from a group consisting of praseodymium iodide, praseodymium bromide, and praseodymium chloride.

8. The lamp system as set forth in claim 6, wherein
said mercury is contained in an amount of 2 mg/cm³ or more in a volume of said bulb.

9. The lamp system as set forth in claim 6, wherein
said rare earth halide and said sodium halide are contained in a molar ratio of a corresponding rare earth element to sodium 1:1 to 1:10.

10. The lamp system as set forth in claim 6, wherein
aid rare earth halide and said sodium halide are contained in a molar ratio of a corresponding rare earth element to sodium 1:3.5 to 1:5.5.
